(19) United States
(12) Patent Application Publication
(10) Pub. No.: US 2023/0311688 A1
(43) Pub. Date: Oct. 5, 2023

(54) Autonomous Vehicle System With On-The-Road Recharge Capability

(71) Applicant: INTERNATIONAL BUSINESS MACHINES CORPORATION, ARMONK, NY (US)

(72) Inventors: Saraswathi Sailaja Perumalla, Visakhapatnam (IN); Sarbajit K. Rakshit, Kolkata (IN); HAROLD IAIN KEITH MCCOMBE, Auckland (NZ)

(21) Appl. No.: 17/657,141

(22) Filed: Mar. 30, 2022

(51) Int. Cl. B60L 53/36; B60L 53/53; B60L 53/16

(52) U.S. Cl. CPC B60L 53/36; B60L 53/53; B60L 53/16

(57) ABSTRACT

A system for electrically charging a first autonomous vehicle (that is, the charged vehicle) by a second autonomous vehicle (that is, charging vehicle) through a wired connection while the vehicles are travelling over a roadway (for example, an interstate highway). In some embodiments, multiple charged vehicles may be charged at the same time while driving in tandem with the charging vehicle.

### BACKGROUND

The present invention relates generally to the field of recharging of electric vehicles (for example, recharging vehicles powered in whole, or in part, by lithium type batteries) and also to the field of autonomous vehicles.

U.S. Pat. No. 9,527,394 (“Tang”) states in part as follows: “The transportation system in this invention provides vehicle coupling units which allow the electrical connections and reconfigurations of two or more vehicles together at highway speeds. The coupling unit provides for the bidirectional exchange of electrical power between these vehicles to meet the various power demands of each vehicle. The system is designed to permit coupling and decoupling process of the vehicles while they are traveling at highway speeds . . . . This transportation system allows the electric vehicles to electrically and mechanically couple together for flexible electrical power sharing to achieve the extension of the range of electrically powered vehicles to minimize the time needed for stationary re-charging of electrical vehicles required by electrical charging stations . . . . [T]he guide rail system consists of a very long and sectioned “C” shaped concrete and steel tube with a continuous slot opening on one side (the road side). Within the C-Tube tube is located a two (or one-) wheeled (self-propelled with electric motor) motorcycle framed driver-less vehicle (not shown) with two lateral support wheels running on the top half of the concrete wall of the C-Tube . . . . The self-propelled wheels of the guide member vehicle runs on the single track in the bottom of the C-tube. The guide member vehicle which has a standard lateral coupler unit which projects through the slot and extends out (this extension can be fixed (not motorized), motorized half or motorized full, i.e.,) a sufficient distance so that another vehicle can connect to it laterally side-by-side.”

It is noted that the charging vehicle disclosed in Tang in the quote of the previous paragraph is not considered to be an autonomous vehicle because it cannot drive on roadways.

### SUMMARY

According to an aspect of the present invention, an autonomous vehicle control method is used with charging hardware, an autonomous charging vehicle including a first electrical power store and an autonomous charged vehicle including a second electrical power store. The method includes the following operations open parentheses not necessarily in the following order close parentheses: (i) while the autonomous vehicles are driving in the same direction along a roadway, controlling the charging and charged vehicles to move into a charging alignment position; (ii) while the autonomous vehicles continue to drive in the same direction along the roadway, controlling the charging hardware to form an electrically conductive wired charging connection between the first electrical power store and the second electrical power store; and (iii) after the charging connection has been formed, charging the second electrical power store by the first electrical power store through the electrically conductive wired charging connection.

According to a further aspect of the present invention, an autonomous charging vehicle assembly includes: a charging vehicle body that defines a driving direction and a lateral direction; computer hardware and software for controlling the driving operations and charging operations of the charging vehicle assembly; a first electrical power store; and a charging hardware sub-assembly. The charging hardware sub-assembly is sized, shaped, structured and located to extend in the lateral direction to form a mechanical and electric charging connection with an autonomous charged vehicle when it is driving on a roadway alongside the charging vehicle. During charging, the charging connection transfers electrical energy from the first electrical power store to a second electric power store in the charged vehicle.

According to a further aspect of the present invention, an autonomous vehicle assembly includes: a charging vehicle that includes a charging vehicle body that defines a driving direction and a lateral direction, a first electrical power store and a charging hardware sub-assembly; computer hardware and software for controlling the driving operations and charging operations of the charging vehicle and the charged vehicle; a charged vehicle that includes a charging hardware sub-assembly and a second electrical power store. The charging hardware sub-assemblies of the charging and charged vehicles is collectively sized, shaped, structured an located to form a mechanical and electric charging connection in the lateral direction between the charging and charged vehicles when they are driving side by side in adjacent lanes on a roadway. During charging, the charging connection transfers electrical energy from the first electrical power store to a second electrical power store.

### BRIEF DESCRIPTION OF THE DRAWINGS

FIG. 1 is a block diagram of a first embodiment of an autonomous vehicle control system (AVCS) at a first point in time;

FIG. 2 is a block diagram of the first embodiment AVCS at a second point in time;

FIG. 3 is a block diagram of the first embodiment AVCS at a third point in time;

FIG. 4 is a perspective view of telescoping coupling hardware included in the first embodiment AVCS;

FIG. 5 is a block diagram of a second embodiment of an AVCS;

FIG. 6 is a block diagram of a third embodiment of an AVCS;

FIG. 7 is a perspective view of a charger vehicle portion of the third embodiment AVCS at a first point in time; and

FIG. 8 is a perspective view of the charger vehicle portion at a first point in time.

### DETAILED DESCRIPTION

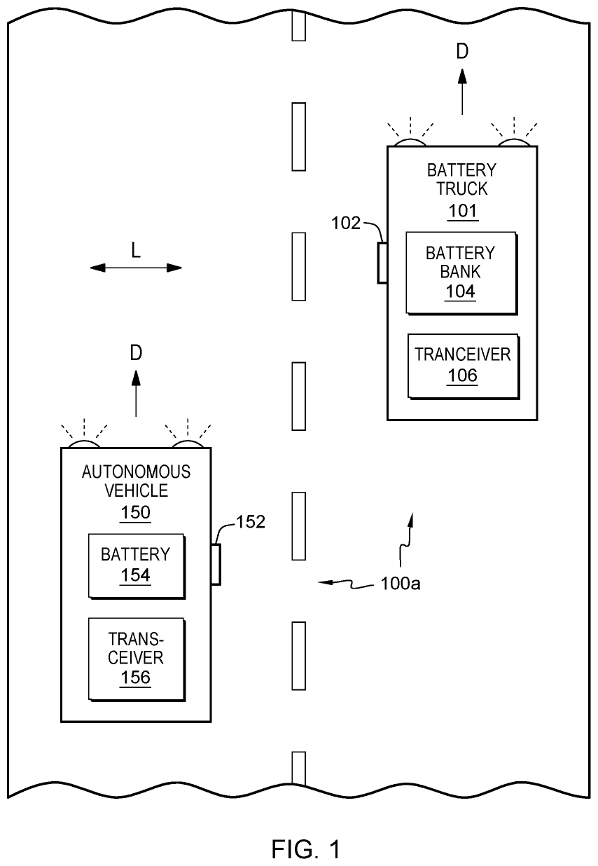

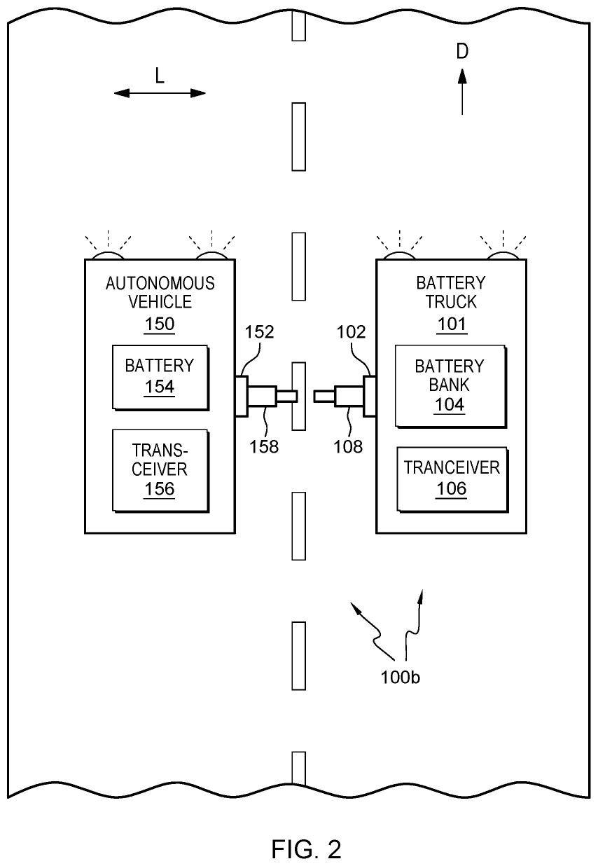

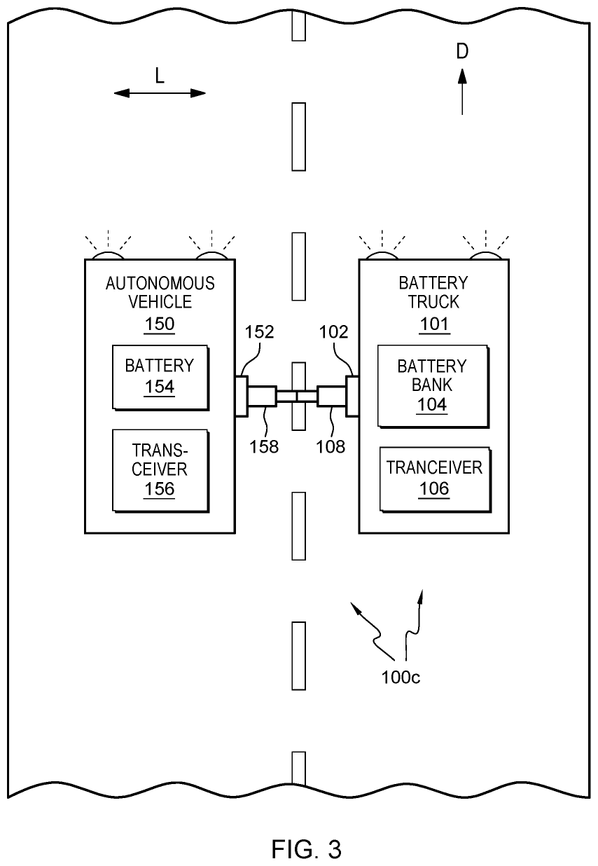

As shown in FIGS. 1 to 4, an autonomous vehicle control system 100 (shown as 100a, 100b and 100c in FIGS. 1 to 3, respectively) incudes: battery truck 101 (including charging port 102, battery bank 104 and transceiver 106); autonomous vehicle 150 (including charging port 152, battery 154 and transceiver 156) and a control computer (not shown in the Figures) located at remote location(s). As shown in FIG. 1, vehicles 101 and 152 are driving in driving direction D down a roadway, under control of machine logic located in the vehicle (not separately shown in the Figures) and/or at the control computer. Lateral direction L is parallel to direction D. As shown, in FIG. 2, vehicles 101 and 152 have each adjusted their speed so that the vehicles are aligned with each other in the driving direction—this alignment is herein referred to as the charging position. However, the vehicles, as shown in FIG. 2, are not performing a charging operation because their charging port hardware, in the form of telescoping arms 108, 158 have not yet moved to a position of mutual contact. As shown in FIG. 3, the telescoping arms have moved into mutual contact, so a wired charging connection is formed between the vehicles driving on the roadway, and, consequently, battery bank 104 of battery truck 101 electrically recharges battery 154 of autonomous vehicle 150.

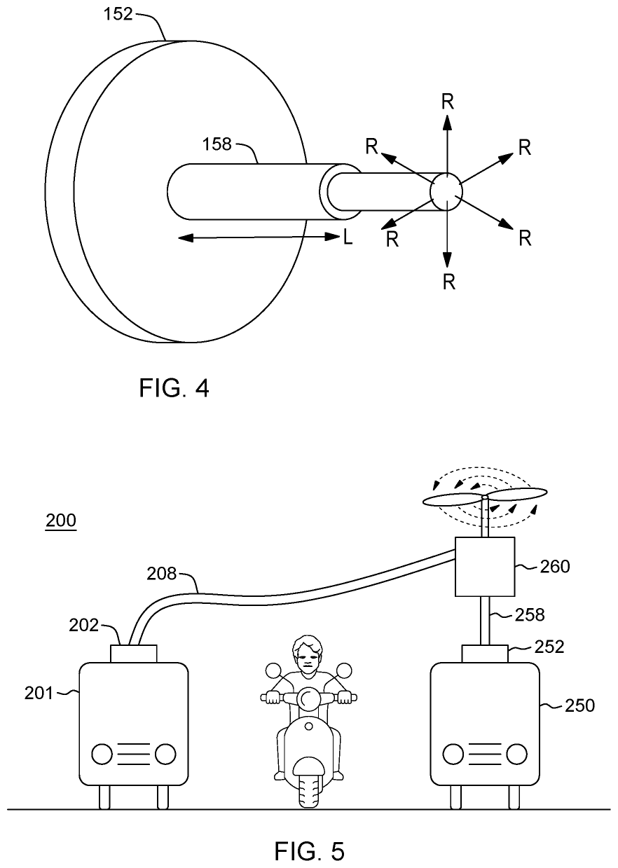

In various embodiments, the charging hardware may be located on either vehicle, or, as in this embodiment, it may be partially located on the charging vehicle and partly located on the charged vehicle. As will be discussed in detail, below, in some embodiments, multiple vehicles can be charged at a time, as the vehicles proceed in a formation down the roadway. In this embodiment, control for driving the vehicles comes from the remote control computer (not shown in the Figures). Alternatively, control over the driving and charging operations may come each of the vehicles involved, or at least some of them (for example, in some embodiments, the charging vehicle may include the machine logic to drive both itself and the charged vehicle(s). As shown in FIG. 4, the charging hardware 152, 158 in this embodiment is structured, sized and shaped to have: (i) a limited degree of freedom of motion in lateral direction L (by its telescoping motion); and (ii) a limited degree of freedom of motion for telescoping arm 158 to pivot, relative to charging port 152 in radial direction R. As will be discussed in the next paragraph, the charging hardware can take many forms, shapes and sizes, so long as it can form a wired electrical connection between autonomous vehicles driving on a roadway.

As shown in FIG. 5, an autonomous vehicle control system 200 incudes: charged vehicle 201 (including charging port 202 and flexible charging hose 208); charging vehicle 250 (including charging port 252, unmanned aerial vehicle (UAV) mounting arm 258); UAV 260 and a control computer (not shown in the Figures) located at remote location(s). As shown in FIG. 5, vehicles 201 and 250 are driving down a roadway while the charged vehicle is charging the charged vehicle through charging hardware 202, 208, 260, 258, 252. In this embodiment, the charging connection is well above the level of most other vehicles on the roadway, such as the motorcyclist shown in FIG. 5. In this embodiment, UAV 260 detaches from its mounting arm on the charging vehicle to retrieve and connect to flexible charging hose 208 so that charging can begin, with electrical power passing through conduction paths built into the UAV itself.

Some embodiments of the present invention recognize the following facts, potential problems and/or potential areas for improvement with respect to the current state of the art: (i) autonomous electric vehicles will be the future mode of travelling; (ii) the vehicles will be recharged from time to time; (iii) the vehicles are to be taken to recharging stations for recharging; (iv) a smart road can recharge the vehicle, but this will have higher infrastructure costs; (v) on any road, multiple electric vehicles might be require power at same/similar time frame; (vi) waiting for a recharging station for battery recharge, and being in queue at the recharging station, will cause delays while travelling; and/or (vii) multiple vehicles recharging, while on the move, is also required to ensure each and every vehicle gets the required power.

Some embodiments of the present invention may include one, or more, of the following operations, features, characteristics and/or advantages: (i) uses a separate power bank autonomous vehicle which can dynamically expand electric power recharge buses on the road; (ii) multiple autonomous vehicles can be recharged from the power bank vehicle in parallel while the autonomous vehicles is running on the road; (iii) the system will be identify which autonomous vehicles need power on the road; and/or (iv) the autonomous vehicles will collaborate with each other and will be align with the power bank autonomous vehicle so that target vehicles can get the required power while on the move.

Some embodiments of the present invention may include one, or more, of the following operations, features, characteristics and/or advantages: (i) the power bank autonomous vehicle will identify in which direction, and how many electric power recharge buses are to be expanded, so that the maximum number of vehicles can be recharged; (ii) the system can allow the emergency vehicle to travel and overtake the power bank autonomous vehicle; (iii) the system will identify which autonomous vehicles needs power, and accordingly based on power requirement with different vehicles, the system will create a batch of autonomous vehicles and will recharge them from the power bank autonomous vehicle; (iv) based on the need of power recharge with the autonomous vehicles, the vehicle recharge service provider will deploy the appropriate power bank autonomous vehicle on the road so that multiple vehicles can be recharged while the vehicles are running; and/or (v) while the power recharge buses are expanded from the power bank autonomous vehicle, the autonomous vehicle will position properly where a flexible power connecting jack on the autonomous vehicles will connect with the power recharge bus for recharging the battery.

Some embodiments of the present invention may include one, or more, of the following operations, features, characteristics and/or advantages: (i) there will be one power bank autonomous vehicle, and this vehicle will be utilizing power stored in multiple batteries; (ii) the power bank autonomous vehicle can also generate power based on any portable power generation system; (iii) the power bank autonomous vehicle will utilize the electric power recharge bus which can be expanded or collapsed as required; (iv) the power recharge bus can be telescopic, foldable, or can be a combination of telescopic and foldable mechanisms; (v) the autonomous vehicles will share the available power from the remote power recharge center; (vi) the system will evaluate which autonomous vehicles needs power for its travel; and/or (vii) the system will identify how much power is required for each vehicle.

Some embodiments of the present invention may include one, or more, of the following operations, features, characteristics and/or advantages: (i) the system will classify the number of vehicles which needs power based on the priority and amount of the power requirement; (ii) the system will identify how many vehicles will require power and how much power will be required; (iii) the power bank autonomous vehicle will expand the power recharge bus in the appropriate direction of the power bank autonomous vehicle; (iv) the autonomous vehicles which need power and the power bank autonomous vehicle will collaborate to find the appropriate positions of the autonomous vehicle; (v) the power bank autonomous vehicle will expand its electric power connection bus so that other autonomous vehicles can be recharged; and/or (vi) the expanded power recharge bus can be a cantilever or can be a supported wheel which will touch the road.

Some embodiments of the present invention may include one, or more, of the following operations, features, characteristics and/or advantages: (i) each and every autonomous vehicle will have a connector jack where there can be a front recharging jack and/or a back recharging jack; (ii) based on the relative position of the autonomous vehicle and the power bank autonomous vehicle, the system will identify which side is to be expanded; (iii) the autonomous vehicles will connect with the electric bus of the power bank autonomous vehicle and will start recharging; (iv) while the autonomous vehicles are being recharged, the power bank autonomous vehicle and the autonomous vehicles will be travelling together on the road; and/or (v) the system will identify if the power charge is completed, and accordingly, the power bank autonomous vehicle and the autonomous vehicle will collaborate to collapse the electric power recharge bus.

Some embodiments of the present invention may include one, or more, of the following operations, features, characteristics and/or advantages: (i) while the autonomous vehicles are being recharged, the system will check if any emergency vehicle is approaching, and accordingly, the autonomous vehicles and the power bank autonomous vehicle will collaborate to collapse the recharging bus; (ii) the emergency vehicle will be travelling and pass by and again the power bank autonomous vehicle will initiate a recharge operation; (iii) based on the completion of recharging the autonomous vehicle, the system will dynamically remove the extended power recharge buses from the power bank autonomous vehicle; and/or (iv) after recharging a first set of autonomous vehicles, another set of autonomous vehicles will be taking their place and will be recharged.

A power bank autonomous vehicle according to an aspect of the present invention can: (i) expand the electric power connection bus and recharge multiple autonomous vehicles; and/or (ii) allow the autonomous vehicle and the power bank autonomous vehicle to collaborate and the connection jack from the autonomous vehicle will be expanded.

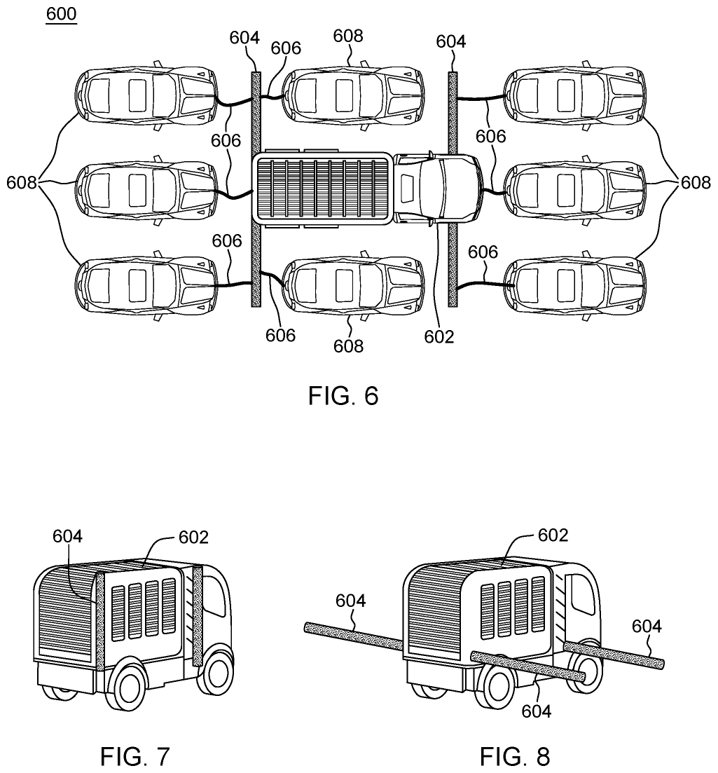

As shown in FIG. 6, AVCS 600 includes: power bank autonomous vehicle 602; main recharge bus 604; secondary recharge buses 606, and autonomous vehicles to be charged 608. FIG. 7 shows power bank autonomous vehicle 602 in a first position with the recharge buses retracted. The first position is suitable for driving on roadways, and through traffic, while not charging any other autonomous vehicles. FIG. 8 shows power bank autonomous vehicle 602 in a second position with its main charge buses 604 extended. The second position is encountered when the charging vehicle is getting set to perform a moving, or stationary, charging operation.

Some embodiments of the present include: (i) a battery array which can regenerate power and store power in the battery; (ii) a power bank autonomous vehicle that: (a) includes a foldable connection bus, and/or (b) includes an expandable power connection bus so that other autonomous vehicles can be recharged; (iii) a power connections which can be expanded; (iv) a flexible jack for recharging; and/or (v) a way for moving vehicles to be recharged from the back of the autonomous vehicle.

Some embodiments of the present invention may include one, or more, of the following operations, features, characteristics and/or advantages: (i) utilizes a power bank autonomous vehicle for parallelly recharging other autonomous vehicles travelling on a road; (ii) utilizes a separate power bank autonomous vehicle to dynamically expand electric power recharge buses on the road to parallelly recharge multiple autonomous vehicles travelling on the road; (iii) identifies which autonomous vehicle needs power on the road, and accordingly batches/collaborates with other autonomous vehicles with each other for aligning with the power bank autonomous vehicle so that target vehicles can get the required power while on the move; (iv) identifies by using the power bank autonomous vehicle, the direction to expand electric power recharge buses to recharge the maximum number of vehicles; (v) allows emergency vehicle to travel and overtake the power bank autonomous vehicle; (vi) deploys a power bank autonomous vehicle on the road at appropriate location, based on the need of power recharge of the autonomous vehicles, so that multiple vehicles can be recharged while the vehicles are running; and/or (vii) properly positions the autonomous vehicles with the power recharge buses, expanded from the power bank autonomous vehicle, and then connects a power jack for recharging the battery.

Some embodiments of the present invention may include one, or more, of the following operations, features, characteristics and/or advantages: (i) utilizes a power bank autonomous vehicle for parallelly recharging other autonomous vehicles travelling on a road by using the power bank autonomous vehicle to determine the direction to expand electric power recharge buses to recharge the maximum number of vehicles; (ii) allows emergency vehicle to travel and overtake the power bank autonomous vehicle: (iii) properly positions the autonomous vehicles with the power recharge buses, expanded from the power bank autonomous vehicle, and then connects a power jack for recharging the battery; and/or (iv) utilizes a power bank autonomous vehicle for parallelly recharging other autonomous vehicles travelling on a road, that is, while they are on the move.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Some embodiments may include the following feature: Based on the traffic conditions, relative position of an emergency vehicle, machine logic the invention will: (i) identify how many vehicles can be recharged; (ii) configure the power bus to best accommodate the identified number of vehicles; and (iii) changes the relative positions of the vehicles as appropriate.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. An autonomous vehicle control method for use with charging hardware, an autonomous charging vehicle including a first electrical power store and an autonomous charged vehicle including a second electrical power store, the method including:
while the autonomous vehicles are driving in the same direction along a roadway, controlling the charging and charged vehicles to move into a charging alignment position;
while the autonomous vehicles continue to drive in the same direction along the roadway, controlling the charging hardware to form an electrically conductive wired charging connection between the first electrical power store and the second electrical power store; and
after the charging connection has been formed, charging the second electrical power store by the first electrical power store through the electrically conductive wired charging connection.

2. The method of claim 1 wherein:
the first electrical power store is a large battery bank with sufficient capacity to charge batteries of many autonomous vehicles; and
the second electrical power store includes a rechargeable electric vehicle battery.

3. The method of claim 1 wherein the charging hardware is located substantially on the charging vehicle.

4. The method of claim 3 wherein the charging hardware includes a plurality of terminals, with each terminal being sized, shaped and located to connect to a different vehicle for charging.

5. The method of claim 3 wherein the charging hardware includes a charging member pivotally connected to the charging vehicle to be pivotable between: (i) a non-charging position such tat the charging member is located along a portion of a body of the charging vehicle, and (ii) a charging position such that the charging member extends laterally from the charging vehicle.

6. The method of claim 1 wherein the charging hardware is sized shaped and located so that the two charging and charged vehicles can drive side by side in adjacent lanes of a roadway when the charging connection has been formed and charging is occurring.

7. An autonomous charging vehicle assembly including:
a charging vehicle body that defines a driving direction and a lateral direction;
computer hardware and software for controlling the driving operations and charging operations of the charging vehicle assembly;
a first electrical power store; and
a charging hardware sub-assembly;
wherein:
the charging hardware sub-assembly is sized, shaped, structured and located to extend in the lateral direction to form a mechanical and electric charging connection with an autonomous charged vehicle when it is driving on a roadway alongside the charging vehicle; and
during charging, the charging connection transfers electrical energy from the first electrical power store to a second electric power store in the charged vehicle.

8. The assembly of claim 7 wherein the first electrical power store is a large battery bank with sufficient capacity to charge batteries of many autonomous vehicles.

9. The assembly of claim 7 wherein the charging hardware includes a bus mounted on a pivoting member that can pivot between an extended position for charging and a retracted position that does not substantially extend outwards from the charging vehicle in the lateral direction.

10. The assembly of claim 7 wherein the charging hardware includes a telescoping member that can move in a telescopic manner between an extended position for charging and a retracted position that does not substantially extend outwards from the charging vehicle in the lateral direction.

11. The assembly of claim 7 wherein the charging hardware includes a plurality of terminals, with each terminal being sized, shaped and located to connect to a different vehicle for charging.

12. The assembly of claim 7 wherein the computer hardware and software for controlling the driving operations and charging operations of the charging vehicle assembly is located, at least in part, at a location that is remote from the charging vehicle body.

13. An autonomous vehicle assembly including:
a charging vehicle that includes a charging vehicle body that defines a driving direction and a lateral direction, a first electrical power store and a charging hardware sub-assembly;
computer hardware and software for controlling the driving operations and charging operations of the charging vehicle and the charged vehicle;
a charged vehicle that includes a charging hardware sub-assembly and a second electrical power store;
wherein:
the charging hardware sub-assemblies of the charging and charged vehicles is collectively sized, shaped, structured and located to form a mechanical and electric charging connection in the lateral direction between the charging and charged vehicles when they are driving side by side in adjacent lanes on a roadway; and
during charging, the charging connection transfers electrical energy from the first electrical power store to a second electrical power store.

14. The assembly of claim 13 wherein the charging hardware of the charging vehicle includes a bus mounted on a pivoting member that can pivot between an extended position for charging and a retracted position that does not substantially extend outwards from the charging vehicle in the lateral direction.

15. The assembly of claim 13 wherein the charging hardware includes a telescoping member that can move in a telescopic manner between an extended position for charging and a retracted position that does not substantially extend outwards from the charging vehicle in the lateral direction.

16. The assembly of claim 13 wherein the computer hardware and software for controlling the driving operations and charging operations of the charging and charged vehicles is located, at least in part, at a location that is remote from the charging vehicle body.
